(19) United States
(12) Patent Application Publication
(10) Pub. No.: US 2021/0138697 A1
(43) Pub. Date: May 13, 2021

(54) SHAPING MATERIAL EXTRUDING HOLLOW MODULE FABRICATING EQUIPMENT AND FABRICATING METHOD OF FOAMED SHAPING MATERIAL HAVING ENCLOSING VENEER

(71) Applicant: Hui-Ping LIN, New Taipei City (TW)

(72) Inventor: Hui-Ping LIN, New Taipei City (TW)

(21) Appl. No.: 16/679,347

(22) Filed: Nov. 11, 2019

(51) Int. Cl. B29C 43/10; B29C 43/20; B29C 43/58; B29C 43/52; B29C 43/36; B29C 69/00

(52) U.S. Cl. CPC B29C 43/10; B29C 43/203; B29C 43/58; B29C 2043/5825; B29C 43/36; B29C 69/001; B29C 43/52

(57) ABSTRACT

A shaping material extruding hollow module fabricating equipment of foamed shaping material having enclosing veneer comprises: a primary machinery, including a shaping material foaming mold allowing a foamed shaping material to be foamed, and disposed with a thermostat device and a blowing pipe; a shaping mold of formation platform, disposed with cooling water passageways and vacuum air passageways; a vacuum shaping mold of formation platform, disposed with cooling water passageways and vacuum air passageways; a shaping water tank mold for flattening the surface of shaping material, disposed with a water tank, a vacuum pump and a shaping block; a secondary machinery, disposed with a shaping material enclosing mold allowing the outer periphery of foamed shaping material to be enclosed by an enclosing veneer of non-foamed plastic and including a thermostat device; a towing device; a cutting device; and a shaping material storage rack adjacently disposed with a detecting device.

### BACKGROUND OF THE INVENTION

### 1. Field of the Invention

The present invention relates to a hollow module fabricating equipment and hollow module fabricating method, especially to a shaping material extruding hollow module fabricating equipment and fabricating method of foamed shaping material having enclosing veneer which allows the interior of the foamed shaping material to be formed with a hollow portion by utilizing a blowing pipe of a shaping material foaming mold, and allows the outer periphery thereof to be enclosed by a layer of an enclosing veneer of non-foamed plastic.

### 2. Description of Related Art

For a conventional door panel, in order to not use natural woods for the purpose of environmental protection, a foaming material is often adopted for forming the whole structure. Because the door panel is made of the above-mentioned foaming material, the structure thereof is solid and heavy, so that it is hard to be transported and the price is high because the selling price is based on the weight, and the transportation cost is inevitably increased. For a conventional door panel made of the foaming material, the surface rigid is insufficient, so that the service life is relatively shorter and the applicable range is limited, and the colors for the door panel made of the foaming material is affected thereby causing the whole structure to be unstable, thus the conventional door panel has a lot of shortages to be improved. Accordingly, the applicant of the present invention has developed a shaping material extruding hollow module fabricating equipment and fabricating method of foamed shaping material having enclosing veneer, which allows the interior of the foamed shaping material to be formed with a hollow portion by utilizing a blowing pipe of a shaping material foaming mold, and allows the outer periphery thereof to be enclosed by a layer of an enclosing veneer of non-foamed plastic, thereby enabling the surface to be smooth and even, reinforcing the surface rigidity, effectively prolonging the service life, reducing the weight and stabilizing the colors.

### SUMMARY OF THE INVENTION

For improving the above-mentioned shortages existed in prior art, one primary objective of the present invention is to provide a shaping material extruding hollow module fabricating equipment and fabricating method of foamed shaping material having enclosing veneer, which allows the interior of the foamed shaping material to be formed with a hollow portion by utilizing a blowing pipe of a shaping material foaming mold and allows the outer periphery thereof to be enclosed by a layer of an enclosing veneer of non-foamed plastic, so that the above-mentioned shortages existed in prior art can be improved.

Another objective of the present invention is to provide a shaping material extruding hollow module fabricating equipment and fabricating method of foamed shaping material having enclosing veneer, which enables the surface to be smooth and even and the surface rigidity to be reinforced.

One another objective of the present invention is to provide a shaping material extruding hollow module fabricating equipment and fabricating method of foamed shaping material having enclosing veneer, which enables the service life to be effectively prolonged, the weight to be reduced and the colors to be stabilized.

For improving the above-mentioned shortages, one technical solution provided by the present invention is to provide a shaping material extruding hollow module fabricating equipment of foamed shaping material having enclosing veneer, which at least comprises:

a primary machinery, wherein the interior thereof is disposed with a shaping material foaming mold allowing a foamed shaping material to be foamed for formation, the interior of the shaping material foaming mold is disposed with at least one thermostat device for heating the foamed shaping material, and the interior of the shaping material foaming mold is also disposed with at least one blowing pipe allowing the foamed shaping material to be formed with a hollow portion;

a shaping mold of formation platform, arranged adjacent to the primary machinery, wherein the interior thereof is disposed with a plurality of cooling water passageways and a plurality of vacuum air passageways allowing the heated foamed shaping material to be initially shaped and slightly cooled;

a vacuum shaping mold of formation platform, arranged adjacent to the shaping mold of formation platform, wherein the vacuum shaping mold of formation platform allows the foamed shaping material having the hollow portion to be fundamentally shaped, and the interior thereof is disposed with a plurality of cooling water passageways and a plurality of vacuum air passageways;

a shaping water tank mold for flattening the surface of shaping material, arranged adjacent to the vacuum shaping mold of formation platform, wherein the interior thereof is disposed with a water tank and a shaping block for flattening the surface of the foamed shaping material and allowing the foamed shaping material to have a desired dimension, and the water tank is disposed with at least one vacuum pump for allowing the water tank to be in a vacuum status;

a secondary machinery, arranged adjacent to the shaping water tank mold for flattening the surface of shaping material, wherein the interior thereof is disposed with a shaping material enclosing mold for allowing the outer periphery of the foamed shaping material to be enclosed by a layer of an enclosing veneer of non-foamed plastic, and the interior of the shaping material enclosing mold is disposed with at least one thermostat device;

a towing device, arranged adjacent to the secondary machinery and used for towing the shaping material of the foamed shaping material having the desired dimension and having the outer periphery being enclosed by the layer of the enclosing veneer of the non-foamed plastic;

a cutting device, arranged adjacent to the towing device and used for cutting the shaping material of the foamed shaping material having the outer periphery being enclosed by the layer of the enclosing veneer of the non-foamed plastic to a desired length; and

a shaping material storage rack, arranged adjacent to the cutting device and used for storing the shaping material of the foamed shaping material having the desired length cut by the cutting device and having the outer periphery being enclosed by the layer of the enclosing veneer of the non-foamed plastic.

Moreover, the present invention further includes a detecting device, arranged adjacent to the shaping material storage rack and used for detecting the appearance and the dimension of the shaping material of the foamed shaping material having the outer periphery being enclosed by the layer of the enclosing veneer of the non-foamed plastic.

Preferably, according to the present invention, the foamed shaping material is a PVC foamed shaping material.

Preferably, according to the present invention, the quantity of the plural cooling water passageways disposed in the vacuum shaping mold of formation platform is greater than the quantity of the plural cooling water passageways disposed in the shaping mold of formation platform.

Preferably, according to the present invention, the vacuum level of the plural vacuum air passageways disposed in the vacuum shaping mold of formation platform is greater than the vacuum level of the plural vacuum air passageways disposed in the shaping mold of formation platform.

Preferably, according to the present invention, the shaping water tank mold for flattening the surface of shaping material is a negative-pressure type shaping water tank mold for flattening the surface of shaping material.

For improving the above-mentioned shortages, one technical solution provided by the present invention is to provide a shaping material extruding hollow module fabricating method of foamed shaping material having enclosing veneer, which comprises the following steps:
(1) Heating a primary machinery and a secondary machinery to a desired temperature by utilizing thermostat devices;
(2) Actuating the primary machinery and the secondary machinery, and respectively disposing a foamed shaping material and non-foamed plastic in the primary machinery and the secondary machinery;
(3) Opening a blowing pipe of a shaping material foaming mold of the primary machinery, and forming a hollow portion of the foamed shaping material by utilizing the blowing pipe;
(4) Allowing the foamed shaping material formed with the hollow portion to pass a shaping mold of formation platform, and allowing the foamed shaping material to be initially shaped and slightly cooled by utilizing a plurality of water cooling passageways and a plurality of vacuum air passageways disposed therein;
(5) Allowing the foamed shaping material to pass a vacuum shaping mold of formation platform, and allowing the shape of the hollow portion of the foamed shaping material to be fundamentally shaped by utilizing a plurality of water cooling passageways and a plurality of vacuum air passageways disposed therein;
(6) Allowing the foamed shaping material to pass a shaping water tank mold for flattening the surface of shaping material, forming a vacuum status in a water tank by utilizing the water tank and a vacuum pump, and allowing the surface of the foamed shaping material to be flattened and allowing the foamed shaping material to have a desired appearance and dimension by utilizing a shaping block;
(7) Allowing an enclosing veneer of the non-foamed plastic to enclose the outer periphery of the foamed shaping material by utilizing the secondary machinery, thereby enhancing the surface smoothness, the appearance and the surface structural strength of the foamed shaping material;
(8) Towing the foamed shaping material having the outer periphery being enclosed by the layer of the enclosing veneer by utilizing a towing device;
(9) Cutting the foamed shaping material having the outer periphery being enclosed by the layer of the enclosing veneer to a desired length by utilizing a cutting device;
(10) Storing the shaping material of the foamed shaping material cut by the cutting device and having the outer periphery being enclosed by the layer of the enclosing veneer by utilizing a shaping material storage rack;
(11) Detecting the appearance and the dimension of the shaping material of the foamed shaping material having the outer periphery being enclosed by the layer of the enclosing veneer by utilizing a detecting device; and
(12) Finished.

Comparing to the prior art, the present invention is able to allow the interior of the foamed shaping material to be formed with the hollow portion by utilizing the blowing pipe of the shaping material foaming mold, and allow the outer periphery thereof to be enclosed by the layer of the enclosing veneer of the non-foamed plastic, thereby enabling the surface to be smooth and even, reinforcing the surface rigidity, effectively prolonging the service life, reducing the weight and stabilizing the colors, and complying the patentability of practical in industrial use, novelty and non-obviousness.

### BRIEF DESCRIPTION OF THE DRAWINGS

FIG. 1 is a block diagram showing a shaping material extruding hollow module fabricating equipment of foamed shaping material having enclosing veneer according to the present invention; and

FIG. 2 is a block diagram showing a shaping material fabricating method of foamed shaping material having enclosing veneer according to the present invention.

### DETAILED DESCRIPTION OF THE PREFERRED EMBODIMENT

Referring to FIG. 1 which is a block diagram showing a shaping material extruding hollow module fabricating equipment of foamed shaping material having enclosing veneer according to the present invention. According to one preferred embodiment of the present invention, the shaping material extruding hollow module fabricating equipment of foamed shaping material having enclosing veneer at least comprises: a primary machinery 6, a shaping mold of formation platform 8, a vacuum shaping mold of formation platform 9, a shaping water tank mold for flattening the surface of shaping material 100, a secondary machinery 7, a towing device 104, a cutting device 105 and a shaping material storage rack 106.

The interior of the primary machinery 6 is disposed with a shaping material foaming mold 61 allowing a foamed shaping material 1000 to be foamed for formation. The interior of the shaping material foaming mold 61 is disposed with at least one thermostat device 60 for heating the foamed shaping material 1000, the interior of the shaping material foaming mold 61 is also disposed with at least one blowing pipe 611 allowing the foamed shaping material 1000 to be formed with a hollow portion 11. According to this embodiment, the foamed shaping material 1000 is a PVC foamed shaping material, but what shall be addressed is that the scope of the present invention is not limited to the above-mentioned PVC foamed shaping material, other foamed shaping materials 1000 are all within the scope of the present invention.

The shaping mold of formation platform 8 is arranged adjacent to the primary machinery 6, and the interior thereof is disposed with a plurality of cooling water passageways 81 and a plurality of vacuum air passageways 82 allowing the heated foamed shaping material 1000 to be initially shaped and slightly cooled.

The vacuum shaping mold of formation platform 9 is arranged adjacent to the shaping mold of formation platform 8, the vacuum shaping mold of formation platform 9 allows the foamed shaping material 1000 having the hollow portion 11 to be fundamentally shaped, and the interior thereof is disposed with a plurality of cooling water passageways 91 and a plurality of vacuum air passageways 92. The quantity of the plural cooling water passageways 91 disposed in the vacuum shaping mold of formation platform 9 is greater than the quantity of the plural cooling water passageways 81 disposed in the shaping mold of formation platform 8; the vacuum level of the plural vacuum air passageways 92 disposed in the vacuum shaping mold of formation platform 9 is greater than the vacuum level of the plural vacuum air passageways 82 disposed in the shaping mold of formation platform 8.

The shaping water tank mold for flattening the surface of shaping material 100 is arranged adjacent to the vacuum shaping mold of formation platform 9, the interior thereof is disposed with a water tank 101 and a shaping block 102 for flattening the surface of the foamed shaping material 1000 and allowing the foamed shaping material 1000 to have a desired appearance and dimension. The water tank 101 is disposed with at least one vacuum pump 103 for allowing the water tank 101 to be in a vacuum status; according to this embodiment, the shaping water tank mold for flattening the surface of shaping material 100 is a negative-pressure type shaping water tank mold for flattening the surface of shaping material.

The secondary machinery 7 is arranged adjacent to the shaping water tank mold for flattening the surface of shaping material 100, the interior thereof is disposed with a shaping material enclosing mold 71 for allowing the outer periphery of the foamed shaping material 1000 to be enclosed by a layer of an enclosing veneer 1081 of non-foamed plastic 108, and the interior of the shaping material enclosing mold 71 is disposed with at least one thermostat device 70.

The towing device 104 is arranged adjacent to the secondary machinery 7 and used for towing the shaping material 1 of the foamed shaping material 1000 having the desired appearance and the dimension and having the outer periphery being enclosed by the layer of the enclosing veneer 1081 of the non-foamed plastic 108.

The cutting device 105 is arranged adjacent to the towing device 104 and used for cutting the shaping material 1 of the foamed shaping material 1000 having the outer periphery being enclosed by the layer of the enclosing veneer 1081 of the non-foamed plastic 108 to a desired length.

The shaping material storage rack 106 is arranged adjacent to the cutting device 105 and used for storing the shaping material 1 of the foamed shaping material 1000 having the desired length cut by the cutting device 105 and having the outer periphery being enclosed by the layer of the enclosing veneer 1081 of the non-foamed plastic 108.

Moreover, the present invention further comprises a detecting device 107 arranged adjacent to the shaping material storage rack 106 and used for detecting the appearance and the dimension of the shaping material 1 of the foamed shaping material 1000 having the outer periphery being enclosed by the layer of the enclosing veneer 1081 of the non-foamed plastic 108.

Referring to FIG. 2, which is block diagram showing a shaping material fabricating method of foamed shaping material having enclosing veneer according to the present invention. According to one preferred embodiment of the present invention, the shaping material fabricating method of foamed shaping material having enclosing veneer comprises the following steps:

(1) Heating the primary machinery 6 and the secondary machinery 7 to a desired temperature by utilizing the thermostat devices 60, 70;

(2) Actuating the primary machinery 6 and the secondary machinery 7, and respectively disposing the foamed shaping material 1000 and the non-foamed plastic 108 in the primary machinery 6 and the secondary machinery 7;

(3) Opening the blowing pipe 611 of the shaping material foaming mold 61 of the primary machinery 6, and forming the hollow portion 11 of the foamed shaping material 1000 by utilizing the blowing pipe 611;

(4) Allowing the foamed shaping material 1000 formed with the hollow portion 11 to pass the shaping mold of formation platform 8, and allowing the foamed shaping material 1000 to be initially shaped and slightly cooled by utilizing the water cooling passageways 81 and the vacuum air passageways 82 disposed therein;

(5) Allowing the foamed shaping material 1000 to pass the vacuum shaping mold of formation platform 9, and allowing the shape of the hollow portion 11 of the foamed shaping material 1000 to be fundamentally shaped by utilizing the water cooling passageways 91 and the vacuum air passageways 92 disposed therein;

(6) Allowing the foamed shaping material 1000 to pass the shaping water tank mold for flattening the surface of shaping material 100, forming a vacuum status in the water tank 101 by utilizing the water tank 101 and the vacuum pump 103, and allowing the surface of the foamed shaping material 1000 to be flattened and allowing the foamed shaping material 1000 to have a desired dimension by utilizing the shaping block 102;

(7) Allowing the enclosing veneer 1081 of the non-foamed plastic 108 to enclose the outer periphery of the foamed shaping material 1000 by utilizing the secondary machinery 7, thereby enhancing the surface smoothness, the appearance and the surface structural strength of the foamed shaping material 1000;

(8) Towing the foamed shaping material 1000 having the outer periphery being enclosed by the layer of the enclosing veneer 1081 by utilizing the towing device 104;

(9) Cutting the foamed shaping material 1000 having the outer periphery being enclosed by the layer of the enclosing veneer 1081 to a desired length by utilizing the cutting device 105;

(10) Storing the shaping material 1 of the foamed shaping material 1000 cut by the cutting device 105 and having the outer periphery being enclosed by the layer of the enclosing veneer 1081 by utilizing the shaping material storage rack 106;

(11) Detecting the appearance and the dimension of the shaping material 1 of the foamed shaping material 1000 having the outer periphery being enclosed by the layer of the enclosing veneer 1081 by utilizing the detecting device 107; and

(12) Finished.

Accordingly, the present invention is able to allow the interior of the foamed shaping material 1000 to be formed with the hollow portion 11 by utilizing the blowing pipe 611 of the shaping material foaming mold 61, and allow the outer periphery thereof to be enclosed by the layer of the enclosing veneer 1081 of the non-foamed plastic 108, thereby enabling the surface to be smooth and even, reinforcing the surface rigidity, effectively prolonging the service life, reducing the weight and stabilizing the colors, and complying the patentability of practical in industrial use, novelty and non-obviousness.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A shaping material extruding hollow module fabricating equipment of foamed shaping material having enclosing veneer, at least comprising:
a primary machinery, having the interior thereof disposed with a shaping material foaming mold allowing a foamed shaping material to be foamed for formation, wherein the interior of the shaping material foaming mold is disposed with at least one thermostat device for heating the foamed shaping material, and the interior of the shaping material foaming mold is disposed with at least one blowing pipe allowing the foamed shaping material to be formed with a hollow portion;
a shaping mold of formation platform, arranged adjacent to the primary machinery, wherein the interior thereof is disposed with a plurality of cooling water passageways and a plurality of vacuum air passageways allowing the heated foamed shaping material to be initially shaped and slightly cooled;
a vacuum shaping mold of formation platform, arranged adjacent to the shaping mold of formation platform, wherein the vacuum shaping mold of formation platform allows the foamed shaping material having the hollow portion to be fundamentally shaped, and the interior thereof is disposed with a plurality of cooling water passageways and a plurality of vacuum air passageways;
a shaping water tank mold for flattening the surface of shaping material, arranged adjacent to the vacuum shaping mold of formation platform, wherein the interior thereof is disposed with a water tank and a shaping block for flattening the surface of the foamed shaping material and allowing the foamed shaping material to have a desired dimension, and the water tank is disposed with at least one vacuum pump for allowing the water tank to be in a vacuum status;
a secondary machinery, arranged adjacent to the shaping water tank mold for flattening the surface of shaping material, wherein the interior thereof is disposed with a shaping material enclosing mold for allowing the outer periphery of the foamed shaping material to be enclosed by a layer of an enclosing veneer of non-foamed plastic, and the interior of the shaping material enclosing mold is disposed with at least one thermostat device;
a towing device, arranged adjacent to the secondary machinery and used for towing the shaping material of the foamed shaping material having the desired dimension and having the outer periphery being enclosed by the layer of the enclosing veneer of the non-foamed plastic;
a cutting device, arranged adjacent to the towing device and used for cutting the shaping material of the foamed shaping material having the outer periphery being enclosed by the layer of the enclosing veneer of the non-foamed plastic to a desired length; and
a shaping material storage rack, arranged adjacent to the cutting device and used for storing the shaping material of the foamed shaping material having the desired length cut by the cutting device and having the outer periphery being enclosed by the layer of the enclosing veneer of the non-foamed plastic.

2. The shaping material extruding hollow module fabricating equipment of foamed shaping material having enclosing veneer as claimed in claim 1, wherein a detecting device is arranged adjacent to the shaping material storage rack and used for detecting the appearance and the dimension of the shaping material of the foamed shaping material having the outer periphery being enclosed by the layer of the enclosing veneer of the non-foamed plastic.

3. The shaping material extruding hollow module fabricating equipment of foamed shaping material having enclosing veneer as claimed in claim 1, wherein the foamed shaping material is a PVC foamed shaping material.

4. The shaping material extruding hollow module fabricating equipment of foamed shaping material having enclosing veneer as claimed in claim 1, wherein the quantity of the plural cooling water passageways disposed in the vacuum shaping mold of formation platform is greater than the quantity of the plural cooling water passageways disposed in the shaping mold of formation platform.

5. The shaping material extruding hollow module fabricating equipment of foamed shaping material having enclosing veneer as claimed in claim 1, wherein the vacuum level of the plural vacuum air passageways disposed in the vacuum shaping mold of formation platform is greater than the vacuum level of the plural vacuum air passageways disposed in the shaping mold of formation platform.

6. The shaping material extruding hollow module fabricating equipment of foamed shaping material having enclosing veneer as claimed in claim 1, wherein the shaping water tank mold for flattening the surface of shaping material is a negative-pressure type shaping water tank mold for flattening the surface of shaping material.

7. A shaping material extruding hollow module fabricating method of foamed shaping material having enclosing veneer, which comprises the following steps:
(1) Heating a primary machinery and a secondary machinery to a desired temperature by utilizing thermostat devices;
(2) Actuating the primary machinery and the secondary machinery, and respectively disposing a foamed shaping material and non-foamed plastic in the primary machinery and the secondary machinery;
(3) Opening a blowing pipe of a shaping material foaming mold of the primary machinery, and forming a hollow portion of the foamed shaping material by utilizing the blowing pipe;
(4) Allowing the foamed shaping material formed with the hollow portion to pass a shaping mold of formation platform, and allowing the foamed shaping material to be initially shaped and slightly cooled by utilizing a plurality of water cooling passageways and a plurality of vacuum air passageways disposed therein;
(5) Allowing the foamed shaping material to pass a vacuum shaping mold of formation platform, and allowing the shape of the hollow portion of the foamed shaping material to be fundamentally shaped by utilizing a plurality of water cooling passageways and a plurality of vacuum air passageways disposed therein;
(6) Allowing the foamed shaping material to pass a shaping water tank mold for flattening the surface of shaping material, forming a vacuum status in a water tank by utilizing the water tank and a vacuum pump, and allowing the surface of the foamed shaping material to be flattened and allowing the foamed shaping material to have a desired appearance and dimension by utilizing a shaping block;
(7) Allowing an enclosing veneer of the non-foamed plastic to enclose the outer periphery of the foamed shaping material by utilizing the secondary machinery, thereby enhancing the surface smoothness, the appearance and the surface structural strength of the foamed shaping material;
(8) Towing the foamed shaping material having the outer periphery being enclosed by the layer of the enclosing veneer by utilizing a towing device;
(9) Cutting the foamed shaping material having the outer periphery being enclosed by the layer of the enclosing veneer to a desired length by utilizing a cutting device;
(10) Storing the shaping material of the foamed shaping material cut by the cutting device and having the outer periphery being enclosed by the layer of the enclosing veneer by utilizing a shaping material storage rack;
(11) Detecting the appearance and the dimension of the shaping material of the foamed shaping material having the outer periphery being enclosed by the layer of the enclosing veneer by utilizing a detecting device; and
(12) Finished.
